(19) United States
(12) Patent Application Publication
(10) Pub. No.: US 2018/0062338 A1
(43) Pub. Date: Mar. 1, 2018

(54) USE OF A CARBON COMPOSITE MATERIAL FOR MANUFACTURING ELECTRICAL CONTACT ELEMENTS FOR A FUEL PUMP, AND CONTACT ELEMENT

(71) Applicant: SCHUNK HOFFMANN CARBON TECHNOLOGY AG, Bad Goisem (AT)

(72) Inventors: Florian HUBER, Bad Ischl (AT); Martin MAURER, Ebensee (AT)

(21) Appl. No.: 15/562,201

(22) PCT Filed: Mar. 22, 2016
(86) PCT No.: PCT/EP2016/056271

§ 371 Date: Sep. 27, 2017

(30) Foreign Application Priority Data
Mar. 30, 2015 (DE) 10 2015 205 735.6

(51) Int. Cl. H01R 43/12; H01R 39/20; H01R 39/04; H01R 43/06; C08K 3/04; C08K 3/08

(52) U.S. Cl. CPC H01R 43/12; H01R 39/20; H01R 39/045; H01R 43/06; C08K 3/042; C08K 2201/001; C08K 3/046; C08K 2003/0812; C08K 2003/0893; C08K 2003/0806; C08K 3/08

(57) ABSTRACT

The invention relates to the use of a carbon composite material for manufacturing electrical contact elements of a fuel pump operated in a fuel environment, the contact elements being designed as carbon molds, wherein, in addition to carbon, the carbon composite material comprises a thermosetting or thermoplastic binder and a metal content that amounts to more than 0.5% and less than 25% of the total mass of the carbon composite material.

The present invention relates to the use of a carbon composite material for manufacturing electrical contact elements of a fuel pump operated in a fuel environment, the contact elements being designed as carbon molds, wherein, in addition to carbon, the carbon composite material comprises a thermosetting or thermoplastic binder and a metal content that amounts to more than 0.5% and less than 25% of the total mass of the carbon composite material.

In the manufacture of electrical contact elements designed as carbon molds, such as carbon brushes, it is known for different binders to be used, which, in combination with the carbon and any additives, such as solid lubricants and cleaning agents, are processed into a carbon composite material in a compression molding process.

For instance, EP 1 713 148 A1 discloses a process for the production of carbon brushes in which metal powder is added to a powdery mixture of a carbon powder and a thermoplastic binder and the powder mixture is processed into a carbon mold in a compression molding process. In the known carbon composite material, metal powder is added to the carbon in order to reduce the material resistance of the carbon brush and the contact resistance between the carbon brush and the commutator in the low voltage range. In particular when the carbon brushes are used in an automobile on-board electrical system having a line voltage of 12 V, adding a metal powder at a ratio of 30 to 60% by weight is recommended.

Where brush-operated fuel pumps are concerned, since they are operated in a fuel environment, there are special operating conditions for the carbon brushes and the commutator segments interacting with the carbon brushes that cannot be compared to operating conditions outside of the fuel environment. It has been found in particular that temporary over-voltages exceeding 14 V in this fuel environment may significantly shorten the service life of the brush/commutator systems because the is wear of brushes and of the commutator increases significantly as a result of the overvoltages.

Hence, the object of the present invention is to reduce the wear of a brush/commutator system of a fuel pump operated in a fuel environment. This object is attained by the use of a carbon composite material for manufacturing electrical contact elements that are designed as carbon molds according to the features of claim 1.

Surprisingly, in a fuel environment, the use of a carbon composite material that, in addition to carbon and a thermosetting or thermoplastic binder, comprises a metal content that amounts to more than 0.5% and less than 25% of the total mass of the carbon composite material has presented itself as the solution to the object stated above.

The use of the carbon composite material according to the invention proves particularly advantageous if the fuel pump is connected to a automobile on-board electrical system having a line voltage of 12 V. Notwithstanding the teaching of EP 1 713 148 A1, which is based on the basic approach of reducing the wear of the carbon brushes in an automobile on-board electrical system having a line voltage 12 V by reducing the resistance of the carbon material by admixing a metal powder in the amount of 30 to 60% of the total mass of the carbon material, it was found that, in a fuel environment, a comparatively smaller metal content leads to better results in terms of reduction of wear in the carbon brush/commutator system.

The use of a carbon composite material that has a metal content amounting to a maximum of 20% of the total mass of the carbon composite to material has proved particularly advantageous.

If the metal content is added to the carbon composite material in the form of powder, a particularly homogenous distribution of the metal content in the carbon composite material can be achieved.

It is particularly advantageous for the metal content to mainly comprise metal particles having a particle diameter of up to 1 mm, a particularly smooth wear being achievable in particular if 80% or particularly preferably 95% of the metal particles have a particle diameter of up to 1 mm.

With respect to the composition of the metal content, it has proved advantageous for the metal content to comprise at least one metal from the group of metals comprising the metals aluminum, zinc and silver.

If the metal content is formed by aluminum or an aluminum alloy, it is particularly advantageous for the metal content to amount to more than 0.5% and less than 20% of the total mass of the carbon composite material.

Advantageously, the metal content consisting of aluminum or an aluminum alloy amounts to a maximum of 10% of the total mass of the carbon composite material.

If the metal content is formed by zinc or a zinc alloy, it is particularly advantageous for the metal content to amount to more than 0.5% and less than 20% of the total mass of the carbon composite material.

Advantageously, the metal content consisting of zinc or a zinc alloy amounts to a maximum of 10% of the total mass of the carbon composite material.

If the metal content is formed by silver or a silver alloy, it is particularly advantageous for the metal content to amount to more than 0.5% and less than 15% of the total mass of the carbon composite material.

Advantageously, the metal content consisting of silver or a silver alloy amounts to a maximum of 10% of the total mass of the carbon composite material.

If the metal content comprises multiple metals, the metal content can be added to the carbon material as an alloy or as a mixture.

The object at hand is also attained by the use of a contact element for forming an electrical contact on a fuel pump, the contact element being designed as a carbon mold made of a carbon composite material according to any one of claims 1 to 16.

Preferably, the contact element used according to the invention is designed as a carbon brush or as a commutator segment of a commutator.

The fuel pump according to the invention comprises at least one carbon brush or one commutator segment that is manufactured from a carbon composite Material according to any one of claims 1 to 16.

Hereinafter, preferred material compositions of carbon composite materials used for manufacturing contact elements of a fuel pump will be listed, the percentages indicated below having a tolerance range of +/−2%, preferably +/−1%.

In a first embodiment, the material used for manufacturing a carbon brush contains, in relation to the total mass of the carbon composite material:
14% thermoplastic binder material,
80% graphite,
1% cleaning agent and
5% aluminum powder.

According to a second embodiment, the material used for manufacturing a carbon brush contains, in relation to the total mass of the carbon composite material:
7% thermosetting binder,
80% graphite,
5% solid lubricant,
1% cleaning agent,
7% aluminum powder.

According to a third embodiment, the material used for manufacturing a carbon brush contains, in relation to the total mass of the carbon composite material:
10% thermoplastic binder,
67% graphite,
5% solid lubricant,
1% cleaning agent,
17% zinc powder.

According to a fourth embodiment, the material used for manufacturing a carbon brush contains, in relation to the total mass of the carbon composite material:
7% thermosetting binder,
80% graphite,
5% solid lubricant,
1% cleaning agent,
7% silver powder.

According to a fifth embodiment, the material used for manufacturing a commutator segment contains, in relation to the total mass of the carbon composite material:
10% thermoplastic binder,
80% graphite,
4% carbon fiber,
6% aluminum powder.

According to a sixth embodiment, the material used for manufacturing a commutator segment contains, in relation to the total mass of the carbon composite material:
10% thermosetting binder,
75% graphite,
15% zinc powder.

According to a seventh embodiment, the material used for manufacturing a commutator segment contains, in relation to the total mass of the carbon composite material:
10% thermoplastic binder,
76% graphite,
2% carbon fiber,
12% aluminum powder.

According to an eighth embodiment, the material used for manufacturing a commutator segment contains, in relation to the total mass of the carbon composite material:
11% thermosetting binder,
80% graphite,
4% carbon fiber,
5% silver powder.

1. A method for manufacturing electrical contact elements of a fuel pump operated in a fuel environment, the method comprising forming a carbon composite material from carbon, at least one of a thermosetting and a thermoplastic binder, and a metal content comprising no more than 0.5% and less that 25% of the total mass of the carbon composite material; and forming contact elements from the carbon composite material in carbon molds.

2. The method of claim 1, further comprising the step of connecting the contact elements of the fuel pump to an automobile on-board electrical system having a line voltage of 12 V.

3. The method according to claim 1 wherein the metal content amounts to a maximum of 20% of the total mass of the carbon composite material.

4. The method of claim 1, wherein the metal content is added to the carbon composite material in the form of powder.

5. The method of claim 4, wherein the metal content comprises metal particles having a particle diameter of up to 1 mm.

6. The method of claim 5, wherein more than 80% of the metal particles have a particle diameter of up to 1 mm.

7. The method of claim 5, wherein more than 95% of the metal particles have a particle diameter of up to 1 mm.

8. The method of claim 1, wherein the metal content comprises at least one metal of the group comprising aluminum, zinc and silver.

9. The method according to claim 8, wherein the metal content is formed by aluminum or an aluminum alloy, and the metal content amounts to more than 0.5% and less than 20% of the total mass of the carbon composite material.

10. The method according to claim 9, wherein the metal content amounts to a maximum of 10% of the total mass of the carbon composite material.

11. The method according to claim 8, wherein if the metal content is formed by zinc or a zinc alloy, and the metal content amounts to more than 0.5% and less than 20% of the total mass of the carbon composite material.

12. The method according to claim 11, wherein the metal content amounts to a maximum of 10% of the total mass of the carbon composite material.

13. The method according to claim 8, wherein the metal content is silver or a silver alloy, and the metal content amounts to more than 0.5% and less than 15% of the total mass of the carbon composite material.

14. The method according to claim 13, wherein the metal content amounts to a maximum of 10% of the total mass of the carbon composite material.

15. The according to claim 8, wherein a metal content comprising a plurality of metals is added to the carbon composite material as an alloy.

16. The according to claim 8, wherein a metal content comprising a plurality of metals is added to the carbon composite material as a mixture.

17. (canceled)

18. The method of claim 1, wherein the contact element is designed as a carbon brush.

19. The method of claim 1, wherein the contact element is designed as a commutator segment of a commutator.

20. A fuel pump comprising at least one carbon brush according to claim 18.

21. A fuel pump comprising at least one commutator segment according to claim 19.
